(19) United States
(12) Patent Application Publication
(10) Pub. No.: US 2017/0198187 A1
(43) Pub. Date: Jul. 13, 2017

(54) Graphene heat dissipation baking varnish

(71) Applicants: Chung-Ping LAI, Zhubei City (TW); Kuo-Hsin CHANG, Dalin Township (TW); Jia-Cing CHEN, Tainan City (TW)

(72) Inventors: Chung-Ping LAI, Zhubei City (TW); Kuo-Hsin CHANG, Dalin Township (TW); Jia-Cing CHEN, Tainan City (TW)

(21) Appl. No.: 14/990,807

(22) Filed: Jan. 8, 2016

(51) Int. Cl. C09K 5/14; C09D 7/12

(52) U.S. Cl. CPC C09K 5/14; C09D 7/1216

(57) ABSTRACT

A graphene baking varnish consists of: graphene, fillers, at least one dispersants, binders, and solvent. The graphene includes graphene nanoflakes and accounts for 20 to70 wt % of solid composition of a graphene baking varnish. The fillers are heat dissipation filler including natural graphite, carbon black, boron nitride, copper (Cu), tin (Sn), iron (Fe), zinc (Zn), nickel (Ni), and sliver (Ag). The at least one dispersant is non-ionic or ionic dispersant. The binder is made of thermoplastic polymers. The solvent possesses one or more carriers. Accordingly, the graphene baking varnish enhances adhesion and improves heat dissipation rate by convection and radiation.

### FIELD OF THE INVENTION

The present invention relates to a graphene baking varnish which enhances adhesion and improves heat dissipation rate by convection and radiation.

### BACKGROUND OF THE INVENTION

Paint consisted of plastic binder, color filler, various additives, and solvent. It was widely used everywhere for beautiful appearance and surface protection function.

For example, paints on metal surface were used to avoid the oxidation, corrosion, and aging of metal.

However, plastic binders and color fillers in paints are electronic and heat insulation. Such plastic paints on metal surface will significantly obstruct the heat dissipation of metal from surface to surroundings.

Graphene, successfully discovered by Andre Geim and Konstantin Novoselov in 2004, has oustanding properties such as high thermal and electric conductivity as well as high surface area. Both properties indicate graphene to be a promising candidate of heat-spreading solution.

Using graphene as filler of paint was disclosed in some inventions. However, the percentage of graphene filler is still relatively low that confines the performance enhancement of graphene in heat dissipation application.

For example, CN 102964972B disclosed an epoxy-based graphene paint was proposed for heat dissipation coating. There is only 0.18˜1.8 wt % graphene in paint.

Other epoxy-based graphene paint was taught in CN 103059636A and was also proposed for car. Less 10 wt % graphene was used in total solid of paint.

0.1˜5wt % graphene solid in non-stick coating was disclosed in CN 103214897B. After coating, 400° C. heat treatment was applied.

Other acrylic-based graphene paint disclosed in CN 103468101A was proposed for heat dissipation coating. There is only 5.9˜7.4 wt % graphene in paint solid.

Less 5 wt % graphene/diamond mixture was used in heat dissipation paste as disclosed in CN103627223A.

0.8˜4.2 wt % graphene was disclosed in CN 104109450A and was used in total solid composition of anti-corrosion painting.

The idea in these inventions was to use relatively small amount of graphene, and graphene was considered as an auxiliary filler for paint.

Primary color fillers and plastic binders are still the main components. They are heat insulators, which confine the effect of graphene on performance improvement.

As illustration in FIGS. 1 and 2, graphene flake was used as an auxiliary filler for paint. Large amount of heat insulator plastic binders and color fillers in paint results in a poor heat conduction of coating.

As shown in FIGS. 1 and 2, numerical reference 10 denotes a metal surface, numerical reference 11 represents paint with low content of graphene flake, numerical reference 12 designates large amount of plastic binders and color fillers, and numerical reference 13 indicates graphene flake, wherein the graphene flake 13 was used as auxiliary filler for paint, and the large amount of plastic binders and color fillers 12 in paint results in a poor heat conduction of coating. In addition, the coating from such binder-rich and color filler-rich paint is a dense layer, which obstruct the surface convection & radiation of paint.

Therefore, using such paint will limit the heat dissipation of metal from surface to surroundings.

The present invention has arisen to mitigate and/or obviate the afore-described disadvantages.

### SUMMARY OF THE INVENTION

The primary objective of the present invention is to provide a graphene baking varnish which enhances adhesion and improves heat dissipation rate by convection and radiation.

To obtain above-mentioned objective, a graphene baking varnish provided by the present invention consists of: graphene, fillers, at least one dispersants, binders, and solvent.

The graphene includes graphene nanoflakes and accounts for 20 to 70 wt % of solid composition of a graphene baking varnish.

The fillers are heat dissipation filler including natural graphite, carbon black, boron nitride, copper (Cu), tin (Sn), iron (Fe), zinc (Zn), nickel (Ni), and sliver (Ag).

The at least one dispersant is non-ionic or ionic dispersant.

The binder is made of thermoplastic polymers.

The solvent possesses one or more carriers.

Preferably, a thickness of the graphene nanoflakes ranges from 1 to 100 nm, and a size of the graphene nanoflakes is from 0.1 to 100 μm.

Preferably, a particle size of the heat dissipation filler is from 10 nm to 100 μm with 0 to 30 wt % of the solid composition of the graphene baking varnish.

Preferably, the at least one dispersant is added at 0.1 to 0.4 wt % of the solid composition of the graphene baking varnish.

Preferably, the binder is accounted for 10 to 60 wt % of the solid composition of the graphene baking varnish.

Preferably, the carriers are aqueous, organic, or inorganic system, and the solvent accounts for 30 to 90 wt % of total composition of the graphene baking varnish.

Preferably, the graphene baking varnish is coated in any one of screen printing, spraying, dipping, and pasting manners.

### BRIEF DESCRIPTION OF THE DRAWINGS

FIG. 1 is a schematic view illustrating graphene flake was used as auxiliary filler for paint.

FIG. 2 is an amplified schematic view of a portion A of FIG. 1 illustrating large amount of heat insulator plastic binders and color fillers in paint results in a poor heat conduction of coating.

FIG. 3 is a schematic view illustrating graphene flake was used as auxiliary filler for paint according to a preferred embodiment of the present invention.

FIG. 4 is an amplified schematic view of a portion B of FIG. 3 illustrating large amount of heat insulator plastic binders and color fillers in paint results in a poor heat conduction of coating according to the preferred embodiment of the present invention.

FIG. 5 shows Table 1, in which the heat dissipation test of Cu metal with various coating according to the preferred embodiment of the present invention.

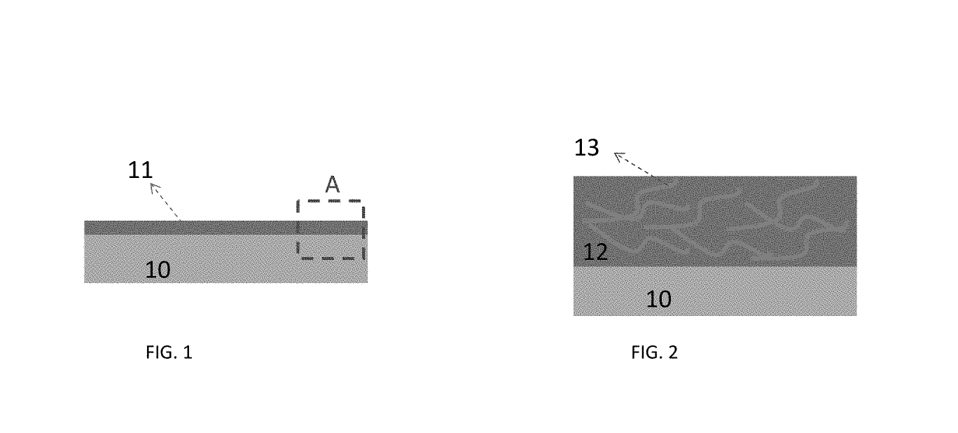

### DETAILED DESCRIPTION OF THE PREFERRED EMBODIMENTS

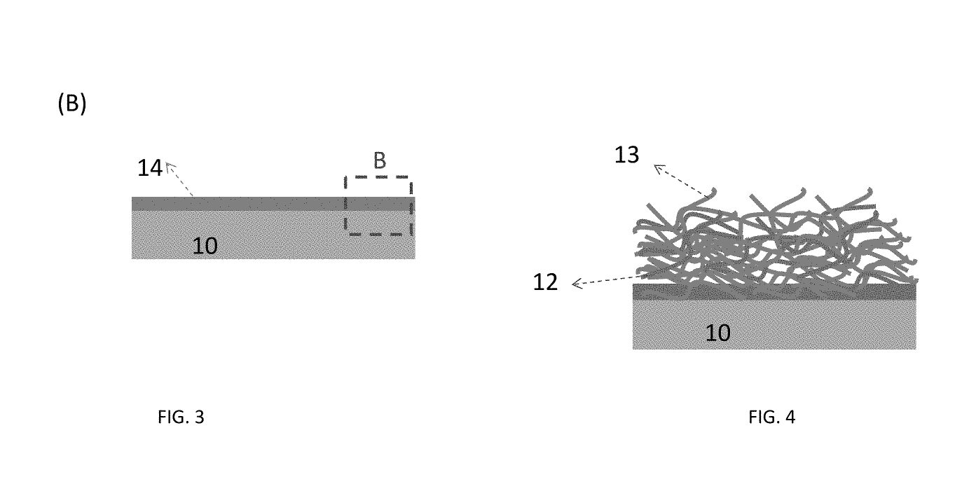

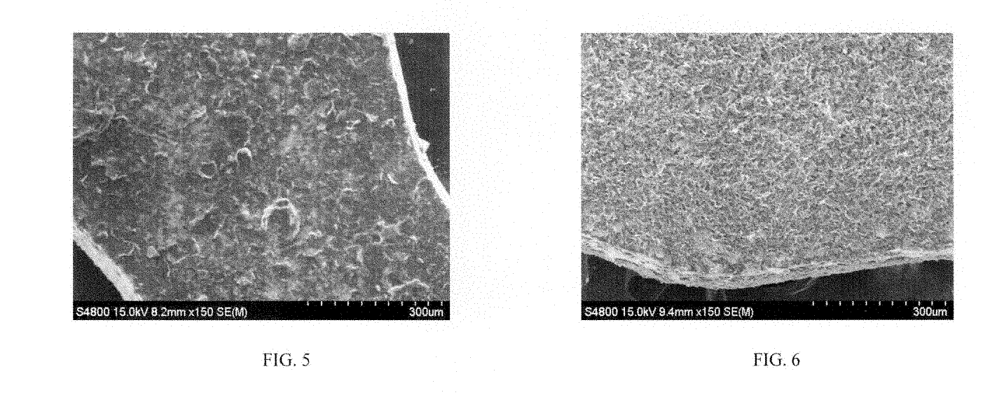

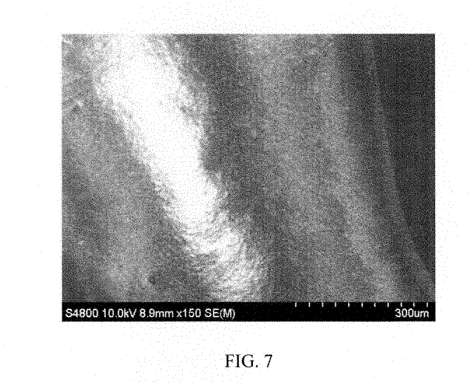

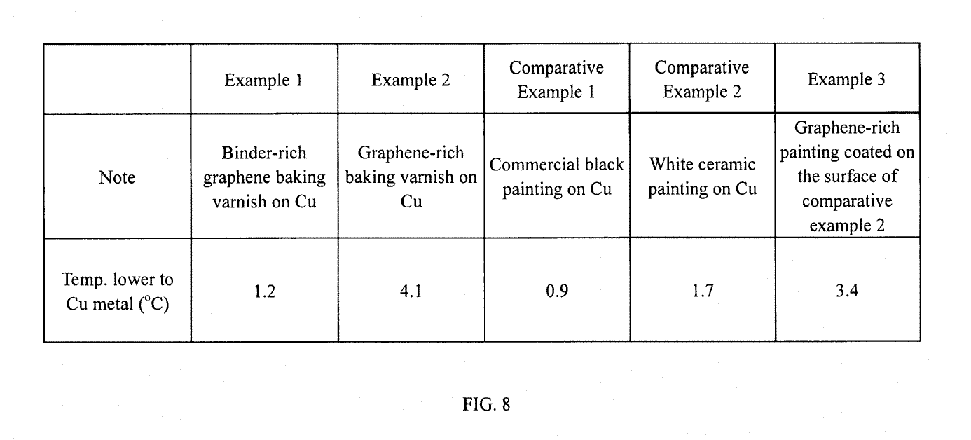

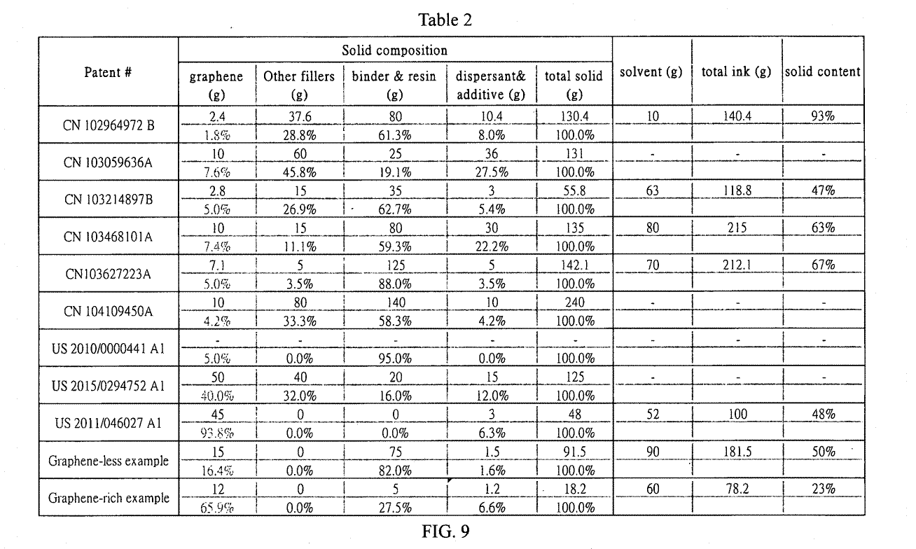

As illustration in FIGS. 3 and 4, numerical reference 10 denotes a metal surface, numerical reference 12 designates plastic binders and color fillers, numerical reference 13 indicates graphene flake, and numerical reference 14 represents paint with high content of graphene flakes, wherein an amount of graphene flakes 13 is raised and content of plastic binders and color fillers 12 is reduced in paint so as to form a porous graphene flake coating layer, thus overcoming the above issue in heat dissipation paint.

In such architecture, porous graphene flake layer can play as a role of micro fin to enlarge the contact area to surroundings and improve the heat dissipation rate by convection and radiation.

Compared to binder-rich and color filler-rich paint, graphene-rich paint exhibits high heat conductivity and supplies a more smooth heat conduction pathway.

However, the adhesion of graphene coating layer will become terrible when we reduce the content of plastic binders. For example, some graphene baking varnish coating will be peeled off by tape.

In order to enhance the adhesion of the graphene flakes 13, we need to use thermoplastic polymers as binders. And a baking treatment at relatively high temperature (100 to 400° C.) is requested after coating.

At relatively high baking temperature, the well mixed thermoplastic binders in coating layer of graphene mixture will soften and flow down along the graphene flakes 13 to the metal surface 10, which not only can enhance the adhesion of the graphene paint 14 in relatively low binder content but also form a protection film on the metal surface 10.

Therefore, a method of enhancing adhesion of the graphene paint 14 contains steps of:
1). coating graphene baking varnish on a surface of the metal 10;
2). drying and baking graphene paint at relatively high temperature (100 to 400° C.); and
3). cooling to a room temperature to form an uniform graphene baking varnish.

Thereby, the graphene baking varnish after baking at relatively high temperature don't be peeled off by the tape.

In this invention, using thermoplastic polymers as binder of the graphene baking varnish is disclosed for heat dissipation coating.

The graphene baking varnish consists of graphene, fillers, at least one dispersant, binders, and solvent.

The primary material for thermal dissipation and radiation is the graphene, wherein the graphene includes graphene nanoflakes, and a thickness of the graphene nanoflakes ranges from 1 to 100 nm, and a size of the graphene nanoflakes is from 0.1 to 100 μm, wherein the graphene accounts for 20 to 70 wt % of solid composition of the graphene baking varnish.

Preferably, the fillers are heat dissipation filler added in the graphene baking varnish, including natural graphite, carbon black, boron nitride, Cu, Sn, Fe, Zn, Ni, Ag metal particles. A particle size of the heat dissipation filler is from 10 nm to 100 μm with 0 to 30 wt % of the solid composition of the graphene baking varnish.

The at least one dispersant is non-ionic or ionic dispersant and is added at 0.1 to 0.4 wt % of the solid composition of the graphene baking varnish.

The binder is made of thermoplastic polymers and is accounted for 10 to 60 wt % of the solid composition of the graphene baking varnish.

The solvent possesses one or more carriers, wherein the carriers is aqueous, organic, or inorganic system, which depends on what thermoplastic binders were used. The solvent accounts for 30 to 90 wt % of total composition of the graphene baking varnish.

Preferably, the graphene baking varnish is coated in any one of screen printing, spraying, dipping, and pasting manners.

To improve the heat dissipation rate, graphene baking varnish is directly coated on metal surface, as illustrated in Example 3 of FIG. 4 or on the top of other paint as shown in Example 4 of FIG. 4.

As the examples, our graphene painting shows the highest temperature cooling of Cu metal. Coating graphene baking varnish on surface can significantly enhance the performance of heat dissipation (see Examples 2 & 4).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A graphene baking varnish consists of: graphene nanoflakes, heat dissipation fillers, at least one dispersants, binders, and carriers;
wherein solid content of graphene baking varnish is 10 to 70 wt %;
wherein an amount of the graphene nanoflakes accounts for 20 to 70 wt % of a solid composition of a graphene baking varnish;
wherein the heat dissipation fillers are selected from natural graphite, carbon black, boron nitride, oxides, copper (Cu), tin (Sn), iron (Fe), zinc (Zn), nickel (Ni), and silver (Ag);
wherein the at least one dispersant is non-ionic or ionic dispersant;
wherein the binder is made of thermoplastic polymers; and
wherein the carriers are selected from aqueous, organic solvents, and a combination thereof.

2. The graphene baking varnish as claimed in claim 1, wherein a composition of the heat dissipation filler is 0.01 to 30 wt % of the solid composition of the graphene baking varnish.

3. The graphene baking varnish as claimed in claim 1, wherein the at least one dispersant is added at 0.1 to 0.4 wt % of the solid composition of the graphene baking varnish.

4. (canceled)

5. The graphene baking varnish as claimed in claim 1, wherein the binder is accounted for 10 to 60 wt % of the solid composition of the graphene baking varnish.

6. The graphene baking varnish as claimed in claim 1, wherein the carriers accounts for 30 to 90 wt % of total composition of the graphene baking varnish.

7. (canceled)

8. (canceled)
